(19) United States
(12) Patent Application Publication
(10) Pub. No.: US 2009/0094548 A1
(43) Pub. Date: Apr. 9, 2009

(54) Information Processing Unit and Scroll Method

(76) Inventors: Fujio NOBORI, Kanagawa (JP); Mamoru Tokashiki, Tokyo (JP); Nariaki Satoh, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/245,145

(22) Filed: Oct. 3, 2008

(30) Foreign Application Priority Data
Oct. 5, 2007 (JP) P2007-262359

(51) Int. Cl. G06F 3/048

(52) U.S. Cl. 715/786

(57) ABSTRACT

An information processing unit according to the present invention, includes: a display portion in which part of plural object display regions which function as an object when object data is displayed is displayed; an object data display control portion which allocates the object data to the plural object display regions so as to display the object data; and an object display region move control portion which scrolls the object display region displayed in the display portion in a scroll direction based on an inputted scroll direction while scrolling the object display region not displayed in the display portion so as to display the object display region in the display portion.

### CROSS-REFERENCE TO RELATED APPLICATION

The present invention contains subject matter related to Japanese Patent Application JP2007-262359 filed in the Japan Patent Office on Oct. 5, 2007, the entire contents of which being incorporated herein by reference.

### BACKGROUND OF THE INVENTION

1. Field of the Invention

The present invention relates to an information processing unit and a scroll method.

2. Description of the Related Art

In various information processing unit such as a personal computer and portable phone in the past, an object such as icon is displayed on a display portion, for example, liquid crystal display and a processing matched with an object selected by user with a position selecting object such as a cursor and mouse pointer is executed. Whether or not operability of selecting of the object is satisfactory is an issue in such an information processing unit.

In the information processing unit described in Japanese Patent Application Laid-Open No. 2002-175139, its upper menu is displayed in carousel system and when a lower menu belonging to the upper menu is displayed, transition from the upper menu to the lower menu is formed to be recognizable easily by user.

### SUMMARY OF THE INVENTION

Upon the above-described selection of the object, all the objects can be hardly displayed on the display portion in many cases because the quantity of the selectable objects is large. In such a circumstance, the displayed object needs to be scrolled corresponding to a user's operation. At this time, smoothness of scrolling the object is one of important factors which determine the operability.

If the information processing unit has a sufficient processing capacity or memory, it is permissible to generate all objects which need to be displayed preliminarily and display any one of objects corresponding to a situation or generate an object when a necessity of displaying the object occurs and display the object. However, for the information processing unit having limited resources like information household electric appliances such as a portable phone and TV, it is difficult to adopt such a method.

For the information processing unit having limited resources like the information household electric appliances such as a portable phone and TV, a method in which a focus position is moved discontinuously so that the scroll of an object is executed such that its content is changed discontinuously is adopted without use of a smooth scroll of the objects, thereby providing a poor operability, which is an issue to be solved.

Accordingly, the present invention has been achieved in views of such an issue and it is desirable to provide a novel and improved information processing unit capable of smoothly scrolling the objects displayed in the display portion under a limited resource environment and a scroll method thereof.

According to an embodiment of the present invention, there is provided an information processing unit, including: a display portion in which part of plural object display regions which function as an object by displaying object data is displayed; an object data display control portion which allocates the object data to the plural object display regions so as to display the object data; and an object display region move control portion which scrolls the object display region displayed in the display portion in a scroll direction based on an inputted scroll direction while scrolling the object display region not displayed in the display portion so as to display the object display region in the display portion.

With such a structure, part of the plural object display regions which function as an object by displaying the object data is displayed in the display portion and the object data display control portion allocates object data to the plural object display regions and displays the object data. The object display region move control portion scrolls the object display region displayed in the display portion in a scroll direction while scrolling an object display region not displayed in the display portion so that the object display region is displayed in the display portion. Because the information processing unit according to the present invention contains two kinds of the object display regions, the object display region displayed in the display portion and the object display region not displayed in the display portion, the object displayed in the display portion can be scrolled smoothly even under a limited resource environment.

The object display regions are disposed in parallel in a predetermined direction, and the scroll in the scroll direction may be carried out in the unit of the row or column of the disposed object display regions.

The object display region move control portion may move the object display region which comes not to be displayed in the display portion as a result of the scroll in the scroll direction to the back of the object display region which comes to be displayed in the display portion as a result of the scroll.

The quantity of the object display regions disposed in a single row or a single column may be at least (quantity of the object display regions disposed in a single row or a single column in the display portion+2) or more.

The object data display control portion may change a transmission factor of the object data allocated to the object display region which comes not to be displayed in the display portion accompanied by move of the object display region so that the transmission factor is decreased.

The object data display control portion may change a transmission factor of the object data allocated to the object display region which comes to be displayed in the display portion accompanied by the move of the object display region so that the transmission factor is increased.

The information processing unit further includes a memory portion for recording the object data, and the object data display control portion may acquire the object data from the memory portion.

The object data display control portion may acquire the object data from an external device connected to the information processing unit.

According to another embodiment of the present invention, there is provided a scroll method for scrolling an object displayed in the display portion, including the steps of: scrolling plural object display regions displayed in the display portion, which function as the object when object data is displayed, according to an inputted scroll method, and displaying the object display region not displayed in the display portion, in the display portion; moving the object display region which comes not to be displayed in the display portion as a result of the scroll in the scroll direction to the back of the object display region which comes to be displayed in the display portion as a result of the scroll; and allocating the object data to the object display region which comes not to be displayed in the display portion after the object display region is moved.

According to still another embodiment of the present invention, there is provided a program which makes a computer function as an information processing unit in which plural object display regions exist in which an object data is displayed and which are capable of being scrolled in a predetermined scroll direction, and part of the plural object display region is displayed in the display portion, so as to make the computer achieve an object data display control function of allocating the object data to the object display regions displayed in the display portion to display the object data; and scrolling the object display region displayed in the display portion in the predetermined scroll direction so as to display the object display region not displayed in the display portion in the display portion.

With such a configuration, the computer program is stored in the memory portion possessed by the computer and read into a CPU possessed by the computer and executed, so as to make the computer function as the information processing unit. Further, a computer readable recording medium in which the computer program is recorded can be provided. The recording medium includes, for example, a magnetic disk, optical disk, photomagnetic disk, and flash memory. The aforementioned computer program may be distributed through, for example, network without use of any recording medium.

According to the embodiments of the present invention described above, two kinds of the object display regions, an object display region displayed in the display portion and an object display region not displayed in the display portion exist. Consequently, the object displayed in the display portion can be scrolled smoothly even under a limited resource environment.

### BRIEF DESCRIPTION OF THE DRAWINGS

FIG. 1 is an explanatory diagram for explaining an example of a system which an information processing unit according to a first embodiment of the present invention can be applied to;

FIG. 2 is an explanatory diagram for explaining an example of an application for use in an information processing unit according to the embodiment;

FIG. 3 is an explanatory diagram for explaining the example of the application for use in the information processing unit according to the embodiment;

FIG. 4 is an explanatory diagram for explaining the example of the application for use in the information processing unit according to the embodiment;

FIG. 5 is an explanatory diagram for explaining the example of the application for use in the information processing unit according to the embodiment;

FIG. 6 is an explanatory diagram for explaining the example of the application for use in the information processing unit according to the embodiment;

FIG. 7 is an explanatory diagram for explaining the example of the application for use in the information processing unit according to the embodiment;

FIG. 8 is an explanatory diagram for explaining the example of the application for use in the information processing unit according to the embodiment;

FIG. 9 is an explanatory diagram for explaining the example of the application for use in the information processing unit according to the embodiment;

FIG. 10 is an explanatory diagram for explaining the example of the application for use in the information processing unit according to the embodiment;

FIG. 11 is an explanatory diagram for explaining the example of the application for use in the information processing unit according to the embodiment;

FIG. 12 is an explanatory diagram for explaining the example of the application for use in the information processing unit according to the embodiment;

FIG. 13 is an explanatory diagram for explaining the example of the application for use in the information processing unit according to the embodiment;

FIG. 14 is a block diagram for explaining functions of the information processing unit according to the embodiment;

FIG. 15 is an explanatory diagram for explaining an example of a screen scroll processing in the information processing unit according to the same embodiment;

FIG. 16 is an explanatory diagram for explaining an example of the screen scroll processing in the information processing unit according to the same embodiment;

FIG. 17 is an explanatory diagram for explaining an example of the screen scroll processing in the information processing unit according to the same embodiment;

FIG. 18 is a flow chart for explaining the screen scroll method in the information processing unit according to the same embodiment; and

FIG. 19 is a block diagram for explaining a hardware structure of the information processing unit according to the same embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### First Embodiment

<About Application Example of Information Processing Unit According to this Embodiment>

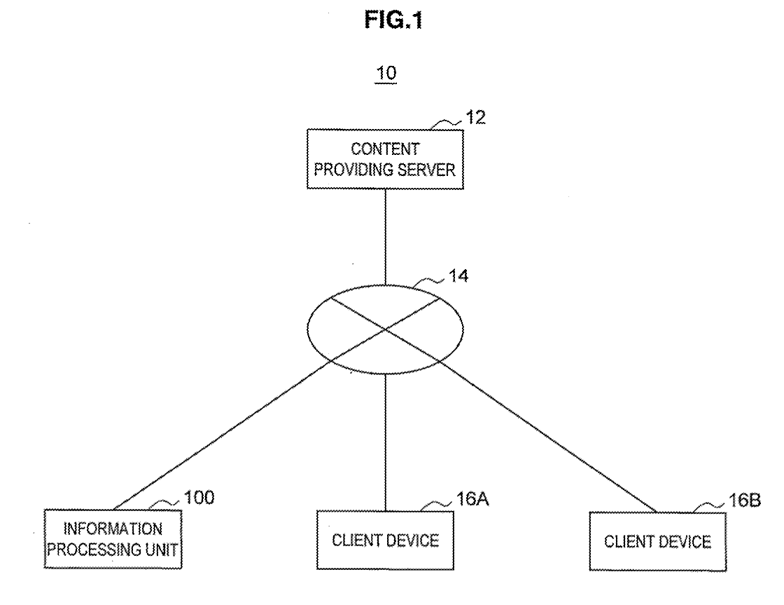

First, an example of the system which an information processing unit 100 according to this embodiment can be applied to will be described in detail with reference to FIG. 1. FIG. 1 is an explanatory diagram for explaining an example of the system which the information processing unit 100 according to this embodiment can be applied to.

The information processing unit 100 according to this embodiment can be used as an information processing unit which can acquire content data from the content providing server 12 so as to reproduce the acquired content data. Hereinafter, a case of using the information processing unit 100 according to this embodiment for the content providing system 10 will be described in detail.

As shown in FIG. 1, in the content providing system 10, the information processing unit 100 according to this embodiment and content providing server 12 are connected through a communication network 14. Further, plural client devices 16A and 16B are connected to the communication network 14.

The content providing server 12 controls contents such as video content, music content, photo content and provides content data and content meta data corresponding to a content controlled by the content providing server 12, in response to a request from the information processing unit 100 or the client device 16. The content providing server 12 may be a digital media server (DMS) based on DLNA guide line.

The communication network 14 is a communication network for connecting the content providing server 12, the information processing unit 100 and the plural client devices 16 to be able to carry out bidirectional communication or single-direction communication. This communication network is constituted of, for example, public network such as Internet, telephone network, satellite network, broadcast network, and leased line network such as wide area network (WAN), local area network (LAN), Internet protocol-virtual private network (IP-VPN), Ethernet (registered trade mark), wireless LAN, while both wired and wireless are used.

The information processing unit 100 is connected to the content providing server 12 through the communication network 14 and receives a list of contents controlled by the server 12 and meta data of the contents from the content providing server 12 and displays a list of reproducible contents. Further, the information processing unit 100 requests the content providing server 12 to provide the content data corresponding to a specification of user of the information processing unit 100 and reproduces the acquired content data. The information processing unit 100 can communicate with the plural client devices 16 through bidirectional communication such as chat. The information processing unit 100 may be DMS based on DLAN guideline or a digital media player (DMP). In the meantime, the information processing unit 100 will be described in detail below.

The client device 16 is connected to the content providing server 12 through the communication network 14 and can reproduce a content acquired from the content providing server 12. The client device 16 can carry out bidirectional communication such as chat between the other client device 16 and the information processing unit 100 through the communication network 14 and the content providing server 12.

In the meantime, the information processing unit 100 and the client device 16 are not limited to a computer unit (regardless of whether the notebook type or desktop type) such as a personal computer (PC), and may be a TV receiver, DVD/HDD recorder, Blu-ray recorder, portable phone, PDA, digital camera and the like. Any device having communication function via network can be constituted of, for example, home use game machine, information household appliance such as digital video camera, TV broadcasting tuner or decoder. The information processing unit 100 and the client device 16 may be a portable device which a subscriber can carry, for example, a portable game machine, PHS, portable video/sound player and the like.

<Example of Application for Use in Information Processing Unit According to this Embodiment>

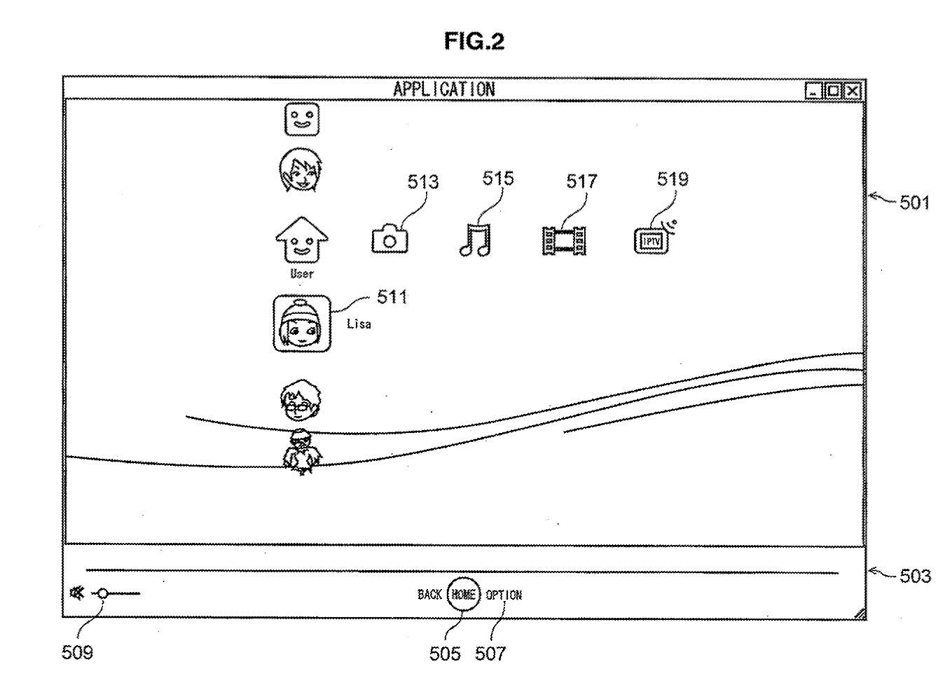

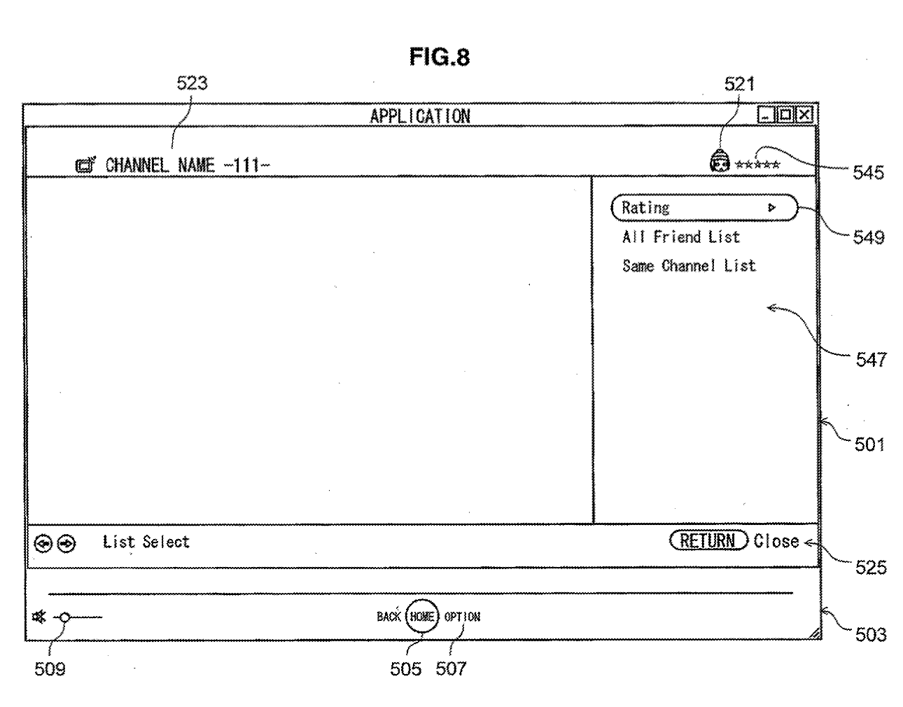

Subsequently, an example of the application for use in an information processing unit 100 of this embodiment will be described with reference to FIG. 2-FIG. 13. FIG. 2-FIG. 13 are explanatory diagrams for explaining an example of an application for use in the information processing unit 100 according to this embodiment.

In the information processing unit 100 according to this embodiment, if an application which allows the content to be watched/listened is started by user's operation, a screen shown in FIG. 2 is displayed as an initial screen. The initial screen includes an information display region 501 in which various kinds of information is displayed, and an operation object display region 503 in which a “HOME” icon 505 for returning to the initial screen, an “OPTION” icon 507 for moving to an option setting screen, a sound volume setting button 509 and other objects are disposed.

User of the information processing unit 100 selects various kinds of contents which user desires to watch or listen to from an user selection icon 511 displayed in the information display region 501 after the user selects an icon corresponding to a user ID for use in watching or listening. Referring to FIG. 2, an icon 513 for reviewing photo content such as still image, an icon 515 for reproducing music content, an icon 517 for watching or listening to a movie content such as animation, an icon 519 for watching or listening to a distribution type content such as IPTV and video on demand (VoD) are disposed as an example of a content which can be watched or listened to. User can enjoy a desired content by selecting these icons.

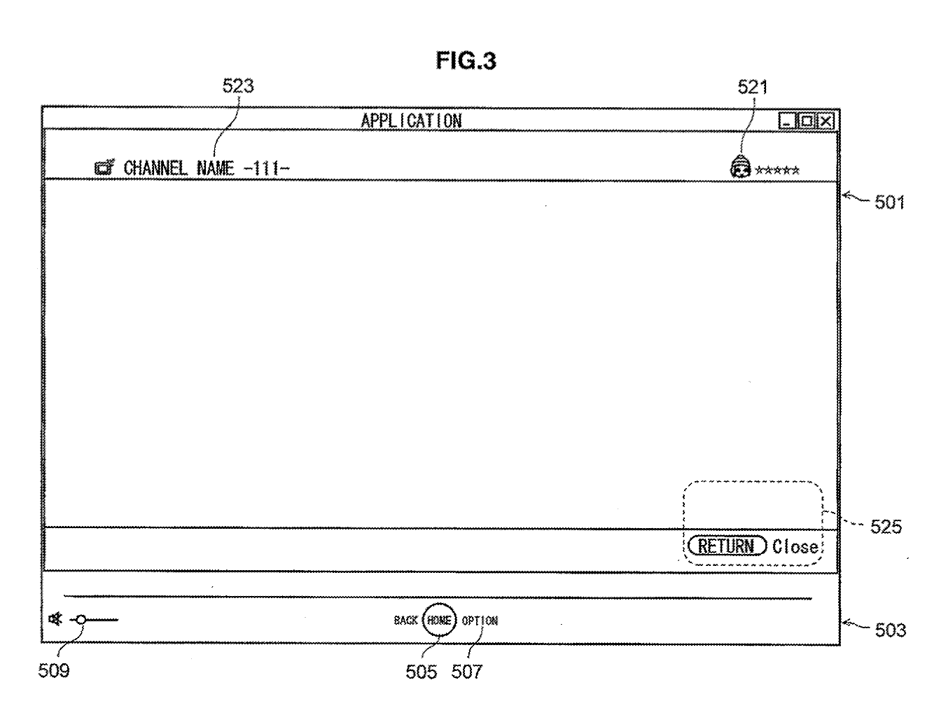

If user selects the icon 519 for watching or listening to a content such as IPITV and after that, determines a desired content for watching/listening, a screen shown in FIG. 3 is displayed on the display portion of the information processing unit 100. In the display screen when any content is watched or listened to, as shown in FIG. 3, user's icon 521 selected on the initial screen and information 523 for specifying a content being watched or listened to such as the name of the content are displayed in the upper portion of the information display region 501, and the content of the content being watched or listened to currently are displayed in other portion of the information display region 501. In an operation object display region 503, a “RETURN” icon for returning to a previous screen, a “CLOSE” icon for closing the screen and an operation object 525 for executing a predetermined operation on the information display region 501 are displayed.

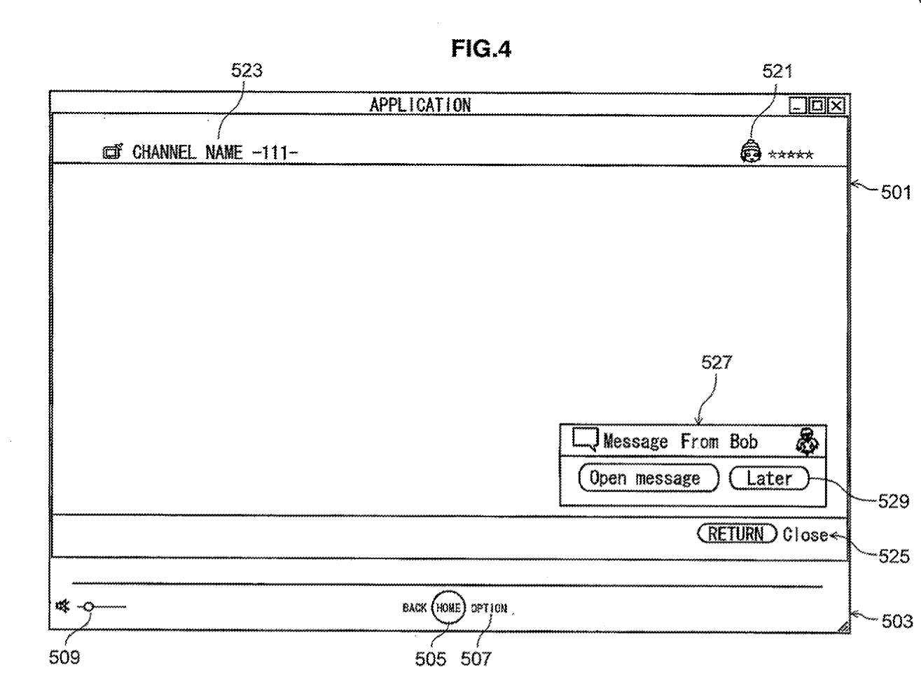

When any content is being watched or listened to, a message is sometimes sent from user of the client device 14 connected to the communication network 12. In that case, message reception information 527 which says that a message is received is displayed in part of the information display region 501 as shown in FIG. 4 and an object 529 for selecting which the message is to be confirmed immediately or later is displayed. User of the information processing unit 100 can select whether or not the received message is to be displayed by selecting any one of the objects 529.

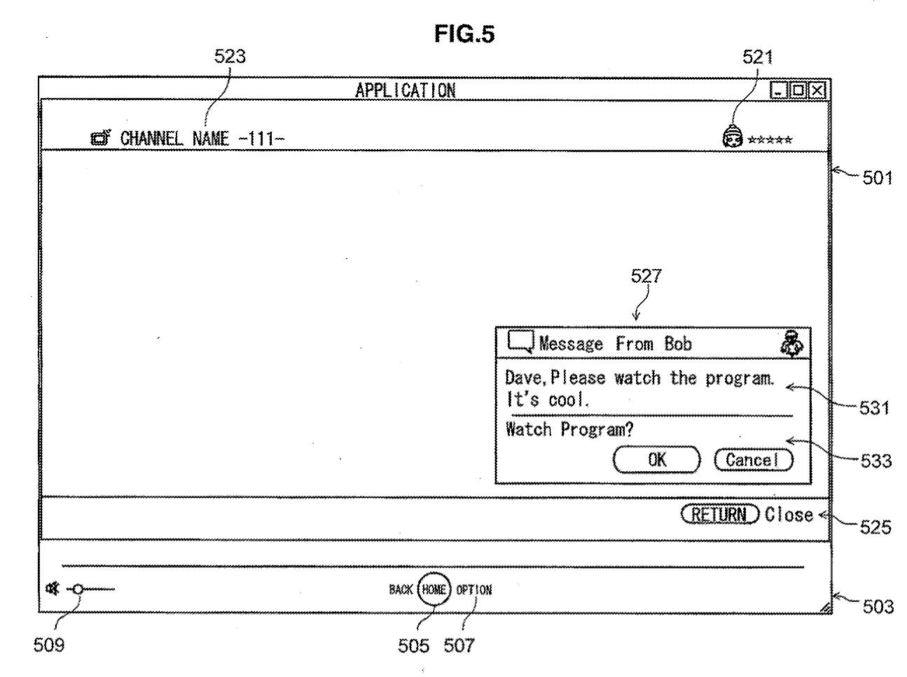

If display of the received message is selected, the received message is displayed in the message display region 531 as shown in FIG. 5. If the received message has information for recommending watching or listening of a content which a sender of that message is watching or listening, a message for confirming whether or not the content which the sender of that message is watching or listening to and an object for executing a switch operation are displayed in a content switching operation object display region 533.

The message display region 531 and content switching operation object display region 533 are disposed within the information display region 501 so that its portion concealing the content of the content displayed in the information display region 501 is as small as possible.

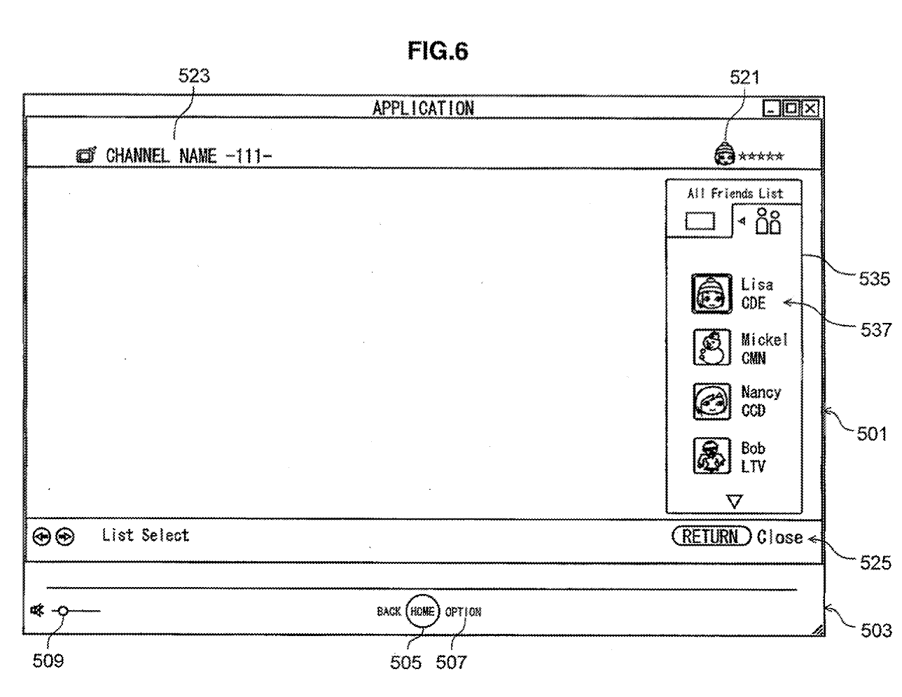

In the application according to this embodiment, by setting information (for example, friend's user ID, address of client device used by the friend, and the like) about friends of the user of the information processing unit 100 preliminarily, whether or not the friend is connected to the content providing server 100 can be determined. More specifically, as shown in FIG. 6, the information display region 501 is provided with a registered ID connecting state display region 535 so as to reduce a portion concealing the content of a content being watched or listened, and objects 537 expressing preliminarily registered friends and friends' ID names are displayed such that they are correlated in this registered ID connecting state display region 535 as “All Friends List”. At this time, by changing an object (for example, avatar or the like) about user connected to the content providing server 100 and the display method of the object about not-connected user, user of an information processing unit 100 can grasp friend's connecting state. For example, by changing the color and the size of the line which surrounds the object 537, changing the transparency of the object 537 or blinking the object 537, user of the information processing unit 200 can grasp the connecting state of friend user visually.

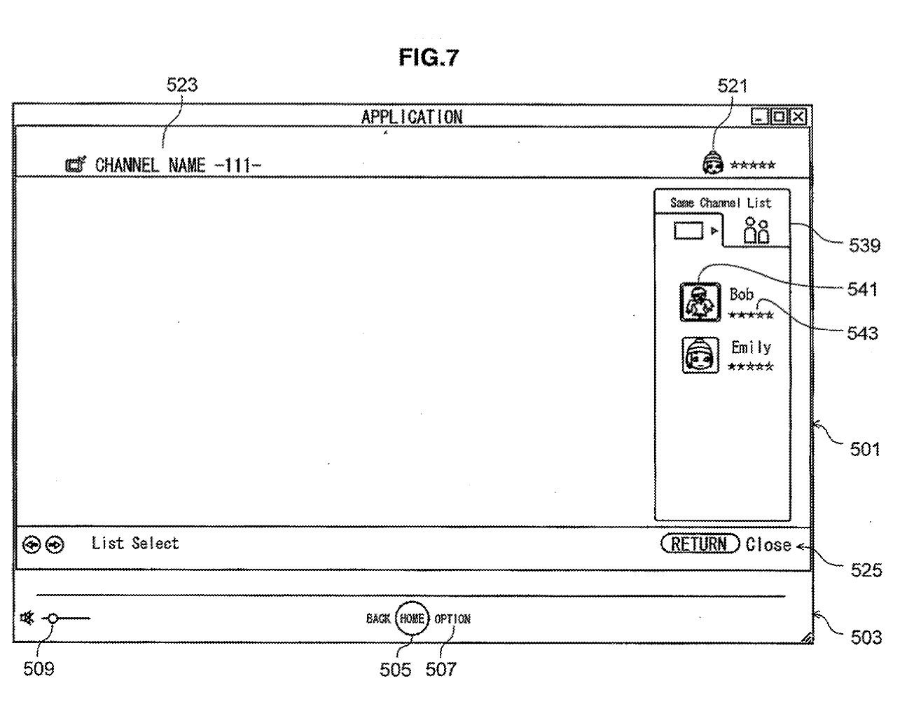

In the application according to this embodiment, a list of other users who watch or listen to the same content as the content which the user of the information processing unit 100 watches or listens to, can be also displayed. As shown in FIG. 7, a same content viewer display region 539 is provided in the information display region 501 so that a portion concealing the content of a content being watched or listened to is minimized and an object 541 of user who watches or listens to the same content is displayed in correlation with user name as “Same Channel List” in the same content viewer display region 539. Further, an evaluation 543 which is performed on any content which the user is watching or listening to is displayed in the object 541 of the user. Although in the example shown in FIG. 7, the evaluation of user is expressed as the number of stars, this embodiment is not limited to the example shown in the same Figure but the evaluation may be expressed in count or using predetermined keywords such as “good”, “normal” and “bad”.

The evaluation on any content being watched or listened to can be performed by the user of the information processing unit 100 also. The evaluation 545 to a content being watched or listened to is expressed as the number of starts such that it adjoins the icon (avatar) 521 indicating user. To change this evaluation, for example, the “OPTION” icon 507 displayed in the operation object display region 503 is selected and an option operation selecting region 547 is displayed in the information display region 501. Subsequently, the evaluation is carried out by selecting an object (“Rating” icon) 549 for evaluation from the option operation information displayed in the option operation selecting region 547.

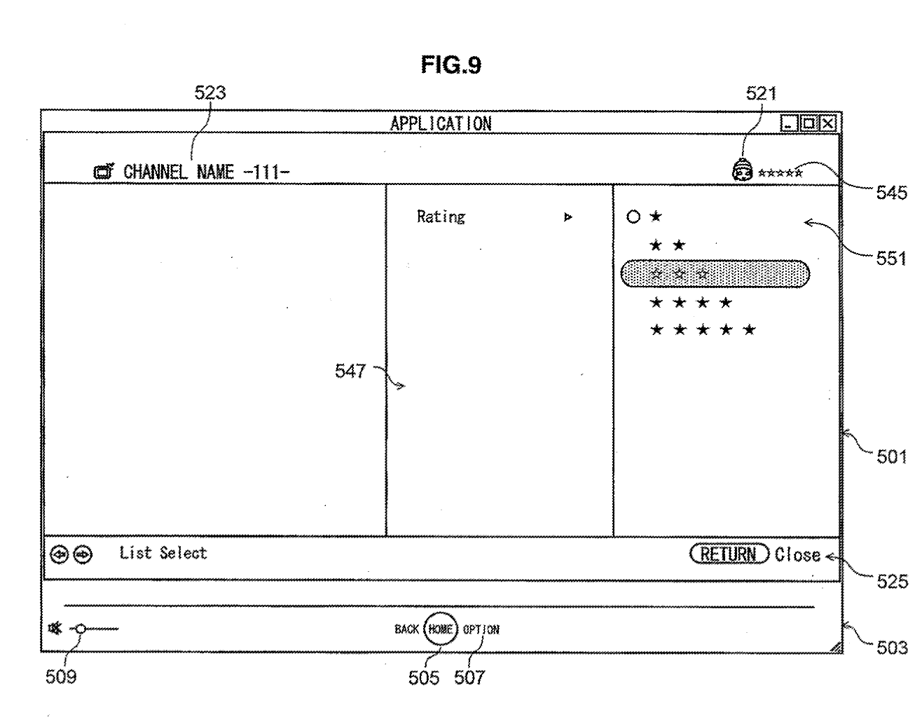

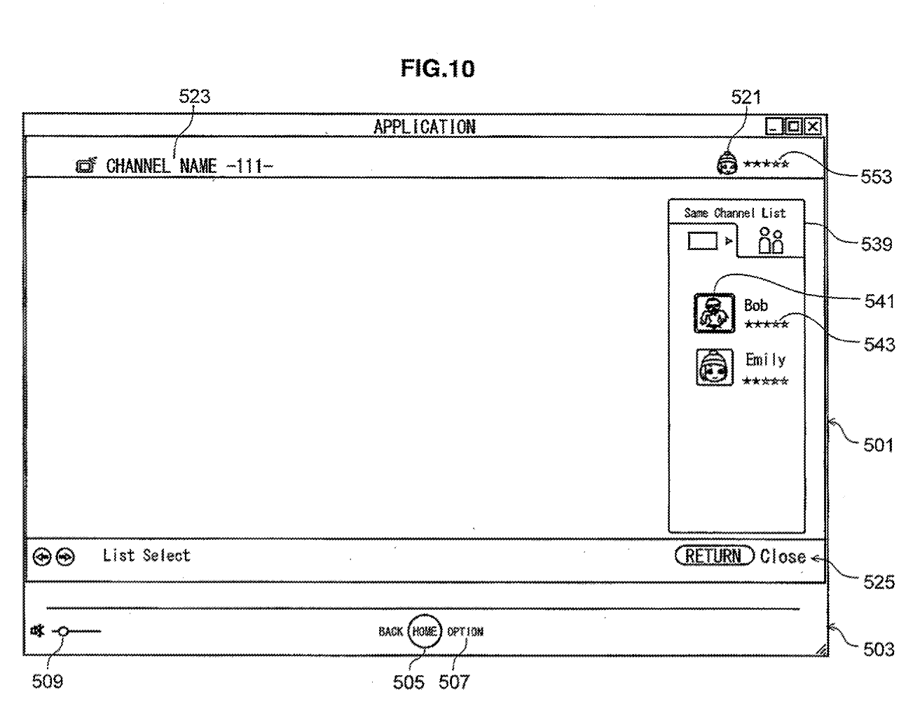

If “Rating” icon 549 is selected, as shown in FIG. 9, an evaluation selection region 551 is displayed adjacent the option operation selection region 547 and a content being watched or listened to can be evaluated by selecting an evaluation content displayed in the evaluation selection region 551. If an evaluation content is selected, evaluation 553 adjacent to an icon 521 indicating user is changed as shown in FIG. 10.

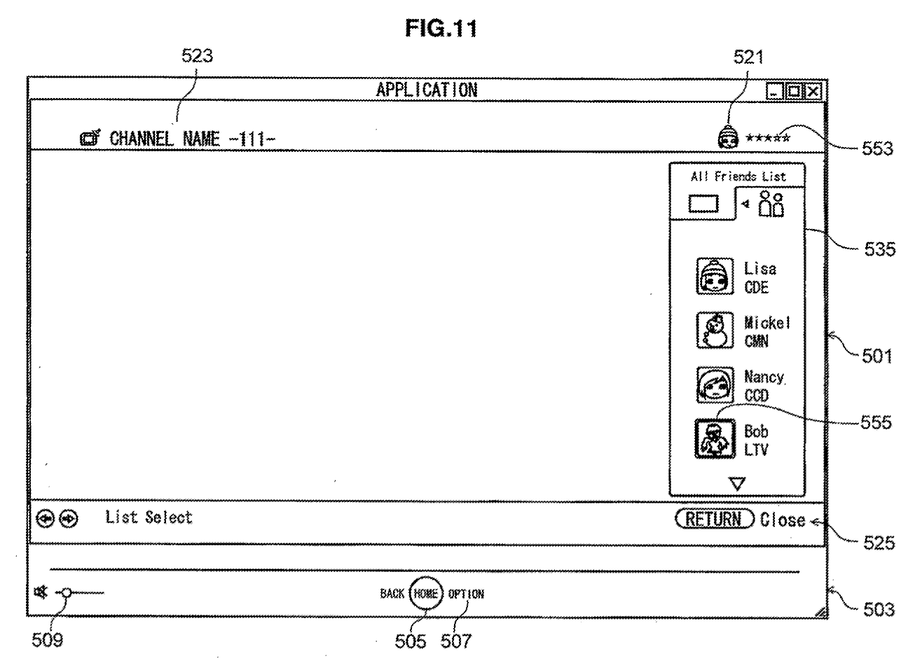

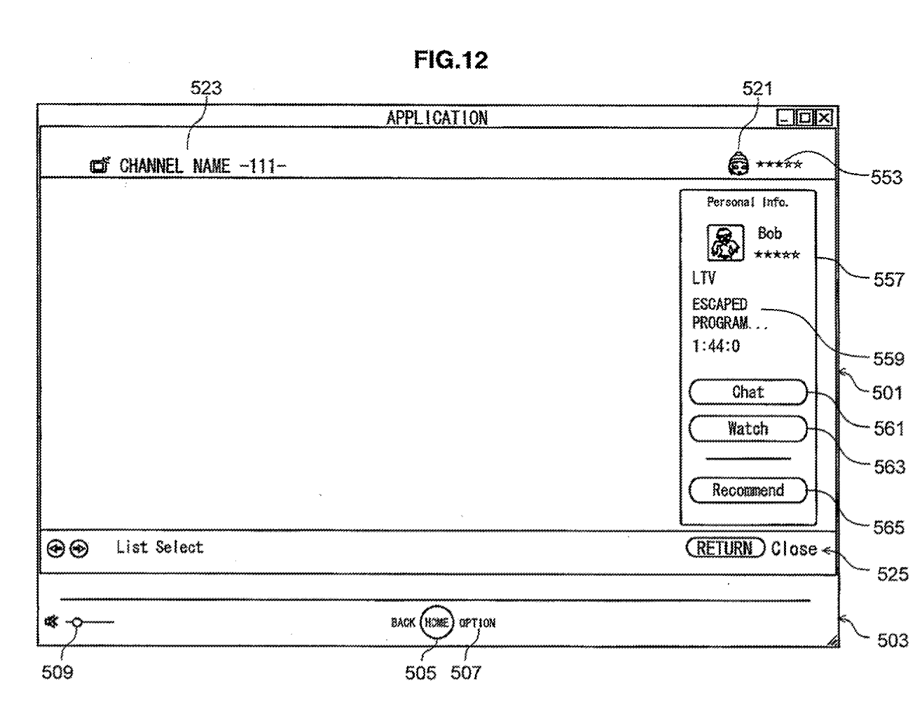

In the application according to this embodiment, detailed information about users can be referred using the other client devices 14. If an object (avatar) 555 expressing user indicated in the registered ID connecting state display region 535 (for example, “All Friends List”) or the same content viewer display region 539 (for example, “Same Channel List”) is selected as shown in FIG. 11, a user information display region 557 is displayed in the information display region 501 as shown in FIG. 12. Information 559 about a content which user watches or listens to currently is displayed in this user information display region 557 as well as the object expressing the user. In the user information display region 557, an object 561 (“Chat” icon) for executing bidirectional communication such as chat with user whose information is expressed and an object (“Watch” icon) 563 for watching or listening to a content which the user whose information is expressed watches or listens to are displayed. Further, an object (“Recommend” icon) 565 for recommending the content watched or listened to by user of the information processing unit 200 to the user whose information is expressed is displayed.

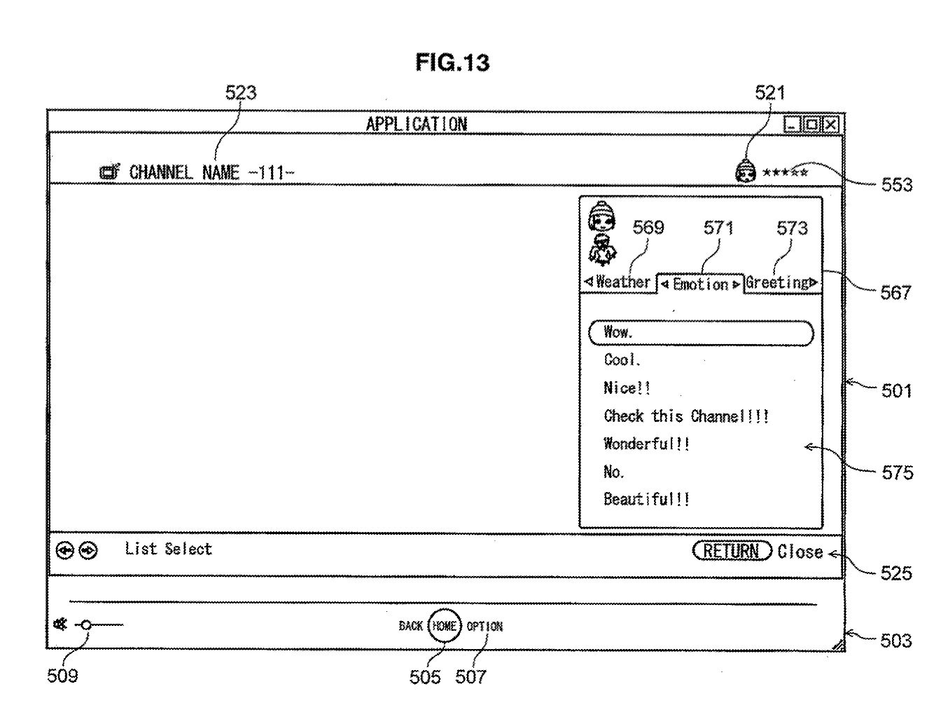

If user of the information processing unit 100 selects the “Chat” icon 561, a message selecting region 567 is displayed in the information display region 501 instead of the user information display region 557 as shown in FIG. 13. In the message selecting region 567, ordinarily used conversation sentences such as tags which collect sentences about the weather (“Weather” tag) 569, tags (“Emotion” tag) 571 which collect sentences about sentiment, tags (“Greeting” tag) 573 which collect expressions about greeting and the like are set up preliminarily for each topic and by selecting sentences 575 which are accommodated in the tags, the bidirectional communication with a specific user such as chat can be carried out.

When user or content shown in FIG. 2 is selected in such an application or user information is displayed as shown in FIG. 6 and FIG. 7, objects such as icons displayed in the display portion may need to be scrolled. When scrolling such an object, the information processing unit 100 according to this embodiment can achieve a smooth object scroll processing even under a limited resource environment.

Such an application is stored in a read only memory (ROM) or random access memory (RAM) or the like of a memory portion provided on the information processing unit 100 and read into a central processing unit (CPU) provided on the information processing unit 100 and executed. Such an application may be stored in a volatile memory provided in the information processing unit 100 or a volatile memory connected to the information processing unit 100. In the meantime, any recording medium in which the application is recorded and can be read by computer may be provided. As the recording medium, for example, a magnetic disk, optical disk, a magneto-optical disk, a flash memory and the like are available. Further, the aforementioned application may be distributed through a network without using any recording medium.

<About Information Processing Unit According to this Embodiment>

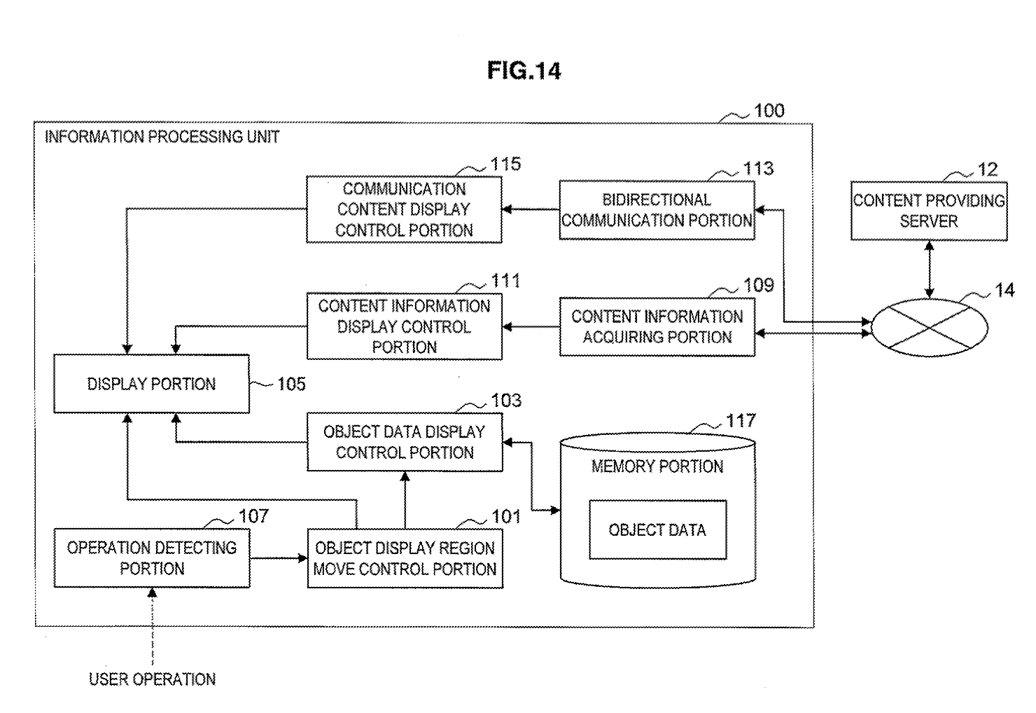

Subsequently, the information processing unit 100 according to this embodiment used in the content providing system 10 as shown in FIG. 1 to FIG. 13 will be described in detail with reference to FIG. 14. FIG. 14 is a block diagram for explaining the function of the information processing unit 100 according to this embodiment used in the content providing system 10.

The information processing unit 100 according to this embodiment for use in the content providing system 10 mainly includes, as shown in FIG. 14, an object display region move control portion 101, object data display control portion 103, display portion 105, operation detecting portion 107, content information acquiring portion 109, content information display control portion 111, bidirectional communication portion 113, communication content display portion 115, and memory portion 1 17.

The object display region move control portion 101 is constituted of, for example, CPU, ROM, RAM and the like so as to control move of the object display region displayed in the display portion 105 described later corresponding to an user operation detected by the operation detecting portion 107 described later. The object display region mentioned here means a region in which object data composed of image data such as icon and avatar and object data composed of text data are displayed, and the aforementioned object data is allocated and displayed in such a region, so that the object display region functions as an object such as a link associated with the icon, avatar or text. The object display region functions as a display frame for displaying object data composed of image data and text data. Further, the above described object display region move control means a control for scrolling the object in up-down direction, right-left direction or in an oblique direction corresponding to an operation of the input device such as the input key and mouse by user.

The quantity of the object display regions which the information processing unit 100 according to this embodiment can use is determined by the processing capacity (for example, processing capacity of CPU or the like) of the information processing unit 100, the quantity of memory resource which the information processing unit 100 can use, the size of the display portion 105 described later and the like. The information processing unit 100 according to this embodiment can display a number of objects in the display portion 105 by effectively using the object display regions of a quantity determined by the above-described factors.

About all object display regions controlled by the object display region move control portion 101, the object display region move control portion 101 mostly grasp which object display region is displayed in the display portion 105 currently and which object display region is not displayed in the display portion 105 and transmits information about such matter to the object data display control portion 103.

The object display region move control portion 101 can achieve a smooth scroll processing of objects by making the control described in detail below upon the move control of the object display region.

The object display region move control portion 101 can make another control on the object display region as well as the move control of the object display region.

The object data display control portion 103 is constituted of, for example, CPU, ROM, RAM and the like so as to allocate object data recorded in the memory portion 117 for example to the object display region and display in the display portion 105. The object data display control portion 103 allocates object data to an object display region displayed in the display portion 105 and an object display region not displayed in the display portion 105 based on information indicating which object display region is displayed in the display portion 105, transmitted from the object display region move control portion 101. Further, the object data display control portion 103 may acquire object data from an external device connected to the information processing unit 100 and allocate the acquired object data to the object display region. Here, the external device connected to the information processing unit 100 may be various kinds of the information processing units connected directly to the information processing unit 100 or various kinds of servers or client devices connected to the information processing unit 100 through a network or communication network.

The object data display control portion 103 may change the transmission factor of object data allocated to the object display region accompanied by move of the object display region by scrolling. For example, if the object display region not displayed in the display portion 105 comes to be displayed in the display portion 105 accompanied by scroll, the object can be faded in the display portion 105 in a natural form without any processing such as trimming by changing the transmission factor of the object data allocated to the object display region from 0% (non-displayed state) toward 100% (completely displayed state). Likewise, if the object display region displayed in the display region 105 comes not to be displayed in the display portion 105, the object can be faded out from the display portion 105 by changing the transmission factor of the object data allocated to the object display region from 100% to 0%. In the meantime, as for the change of the transmission factor, the transmission factor may be changed continuously or the transmission factor may be changed gradually.

The processing performed by the object data display control portion 103 will be described in detail below.

The display portion 105 is an output device possessed by the information processing unit 100 according to this embodiment and for example, a CRT display unit, liquid crystal display unit, plasma display unit, EL display unit and the like are used. Various pieces of display information displayed in the display portion 105 are controlled by the object display region move control portion 101, the object data display control portion 103, the content information display control portion 111 described later, the communication content display control portion 115 and the like.

The operation detecting portion 107 is constituted of, for example, CPU, ROM, RAM and the like, so as to detect an operation of the position specifying object such as the mouse pointer and cursor. The detection for the operation of the position specifying object includes detection about presence/absence of an operation, for example, whether the position specifying object is moving or stopped, detection for specifying a current position of the position specifying object, detection about the direction and scale of the operation, for example, in which direction and how long the position specifying object is moved. The operation detecting portion 107 can execute the above-described processing by detecting the operation of the input device such as the mouse and cursor key for operating the position specifying object.

The operation detecting portion 107 transmits operation information about a detected operation of the position specifying object to the object display region move control portion 101, the content information acquiring portion 109, the content information display control portion 111, the bidirectional communication portion 113 and the communication content display control portion 115.

The content information acquiring portion 109 is constituted of for example, CPU, ROM, RAM, communication unit and the like, and acquires content information including content data and meta data of a content corresponding to the content data from the content providing server 12. The content information acquiring portion 109 outputs the acquired content data to the content information display control portion 111 described later. Further, the content information acquiring portion 109 may record the acquired content data, meta data and the like in the memory portion 117 described later.

If the information processing unit 100 is connected to the content providing server 12 through the communication network 14, the content information acquiring portion 109 according to this embodiment sends an acquisition request for the meta data of a content to the content providing server 12. When the meta data is sent from the content providing server 12 corresponding to the acquisition request, the content information acquiring portion 109 receives the meta data and outputs it to the content information display control portion 111.

The content information display control portion 111 is constituted of, for example, CPU, ROM, RAM and the like, so as to execute display control for displaying the content data in the display portion 105. The content data and meta data are inputted to the content information display control portion 111 from the content information acquiring portion 109, and the content information display control portion 111 executes display control for displaying inputted content data or meta data in the display portion 105. If an operation of the position specifying object such as the mouse pointer and cursor is detected, the display control of the position specifying object is carried out corresponding to the detected operation.

The bidirectional communication portion 113 is constituted of, for example, CPU, ROM, RAM, communication unit and the like so as to control bidirectional communication such as chat to be carried out between the information processing unit 100 according to this embodiment and the other client device 16 connected to the content providing server 12 through the information processing unit 100 and the communication network 14, while the content is reproduced in the display portion 105. Speaking further in detail, the bidirectional communication portion 113 controls the bidirectional communication with the other client device 16 carried out through the content providing server 12 based on user information and communication protocol recorded in the memory portion 117.

The communication content display control portion 115 is constituted of, for example, CPU, ROM, RAM and the like, so that when the information processing unit 100 is carrying out bidirectional communication such as chat with the other client device 16, a communication result is inputted from the bidirectional communication portion 113 so as to execute the display control for displaying the inputted communication result in the display portion 105.

The memory portion 117 records user information about user of the information processing unit 100 and object data about the object which the information processing unit 100 may use. Further, as well as the user information and object data, the memory portion 117 may record various parameters, communication protocol and database for use in controlling the bidirectional communication such as the chat. Additionally, the memory portion 117 may memorize various parameters and a process of processing which are required to be stored when the information processing unit 100 performs some processing, appropriately. The object display region move control portion 101, the object data display control portion 103, the operation detecting portion 107, the content information acquiring portion 109, the content information display control portion 111, the bidirectional communication portion 113 and the communication content display control portion 115 can make writing/reading freely to this memory portion 117.

The memory portion 117 records the applications described with reference to FIG. 2-FIG. 13 and various processings of the information processing unit 100 may be performed based on this application.

An example of the function of the information processing unit 100 according to this embodiment has been shown above. Each component may be constructed using a general purpose member and circuit or of a hardware specified for each of the components. Further, the function of each component may be carried out by CPU or the like. Therefore, the construction for use may be changed appropriately corresponding to each technical level which implements this embodiment.

<About Screen Scroll Processing in Information Processing Unit According to this Embodiment>

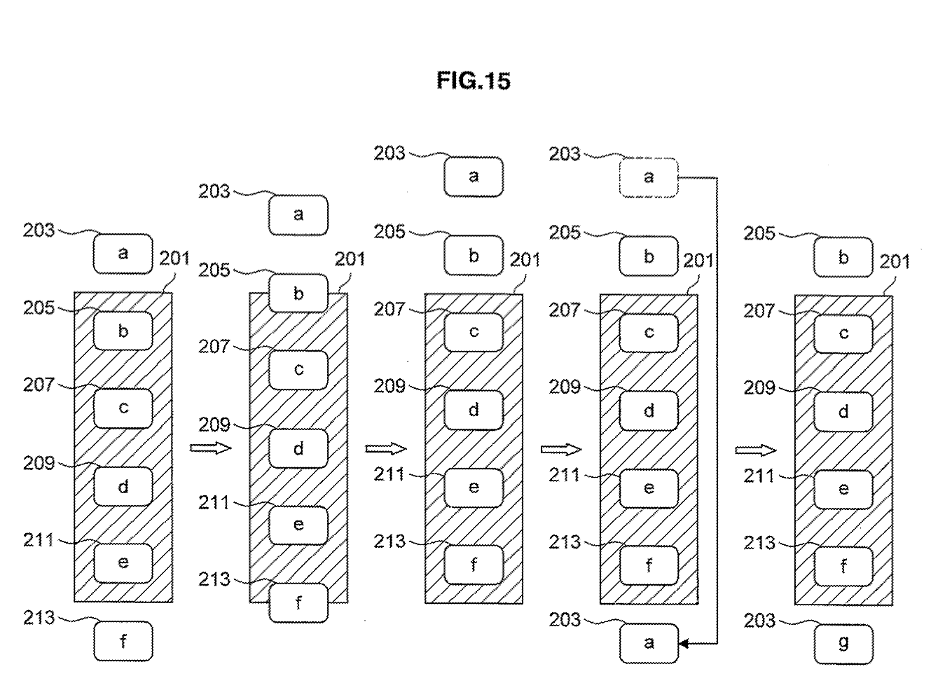

An example of the screen scroll processing in the information processing unit 100 according to this embodiment will be described in detail with reference to FIG. 15 to FIG. 17. FIG. 15 to FIG. 17 are explanatory diagrams for explaining an example of the screen scroll processing in the information processing unit 100 according to this embodiment.

### (About Scroll Processing in Up-Down Direction)

FIG. 15 is an explanatory diagram for explaining screen scroll processing in up-down direction which the information processing unit 100 implements in case where six object display regions which the information processing unit 100 can use are provided and four object display regions are displayed in the display region 201 provided in the display portion 105.

As shown in a leftmost view of FIG. 15, six object display regions, 203 to 213 exist and six object data indicated with a to f are allocated to each of the object display regions. The object display region to which the object data is allocated functions as such an object as the icon and avatar. In the display region 201, four object display regions, 205 to 211 are displayed.

Assume that user of the information processing unit 100 operates a pointing device such as the mouse, keyboard, input key so as to scroll the object display regions 205 to 211 in a upward direction. A user's operation is detected by the operation detecting portion 107 of the information processing unit 100, so that user's scrolling operation in the upward direction is notified to the object display region move control portion 101. The object display region move control portion 101 moves the object display regions 203 and 213 not displayed in the display region 201 as well as the object display regions 205 to 211 displayed in the display region 201 in the upward direction. At this time, the object display region move control portion 101 moves the entire object display regions 203 to 213 smoothly in the upward direction as shown in a second view from the left side of FIG. 15. As a result, the object display region 205 provides a visual effect that it is going out gradually from the display region 201, and the object display region 213 provides a visual effect that it is coming into the display region 201 gradually. At this time, the object data display control portion 103 may change the transmission factor of object data allocated to the object display region accompanied by scroll of the object display region.

As a result of move control by the object display region move control portion 101, as shown in a third view from the left side of FIG. 15, four object display regions 207 to 213 are displayed in the display region 201. Two object display regions 203 and 205, which are not displayed in the display region 201, are located above the object display region 207.

Here, the object display region move control portion 101, as shown in a second view from the right side of FIG. 15, moves an object display region (object display region 203 in the example of FIG. 15) existing at a place most apart from the display region 201 (in other words, most forward place in the scroll direction) in an object display region not displayed in the display region 201 to the further backward of an object (object display region 213 in the example of FIG. 15) located at the most backward place of the object display region displayed in the display region 201 (in other words, most backward place in the scroll direction). As a result of such move control, an object display region, not displayed in the display region 201, exists each above and below the object display 201.

The quantity of the object display regions which the information processing unit 100 uses in this way is preferred to be at least (quantity of the object display regions displayed in the display region 201 plus two) in a scroll direction.

Subsequently, the object data display control portion 103 changes the object data allocated to the object display region 203 from data a to data g as shown in a rightmost view of FIG. 15. Here, the object data g is an object data which is displayed next to object data f when the view on the rightmost side of FIG. 15 is scrolled further upward. Therefore, unless any new object data exists in the back of the object data f, the object data a is kept allocated to the object display region 203.

By such a processing, the object data of a quantity larger than that of the object display regions can be displayed using limited object display regions (six object display regions in the example shown in FIG. 15). The information processing unit using such a method can smoothly scroll the objects displayed in the display portion using the limited resource effectively.

Although in FIG. 15, a case where the object display region is scrolled in the upward direction has been described, the same processing can be done in case where the object display region is scrolled in a downward direction.

### (About Scroll Processing in Right-Left Direction)

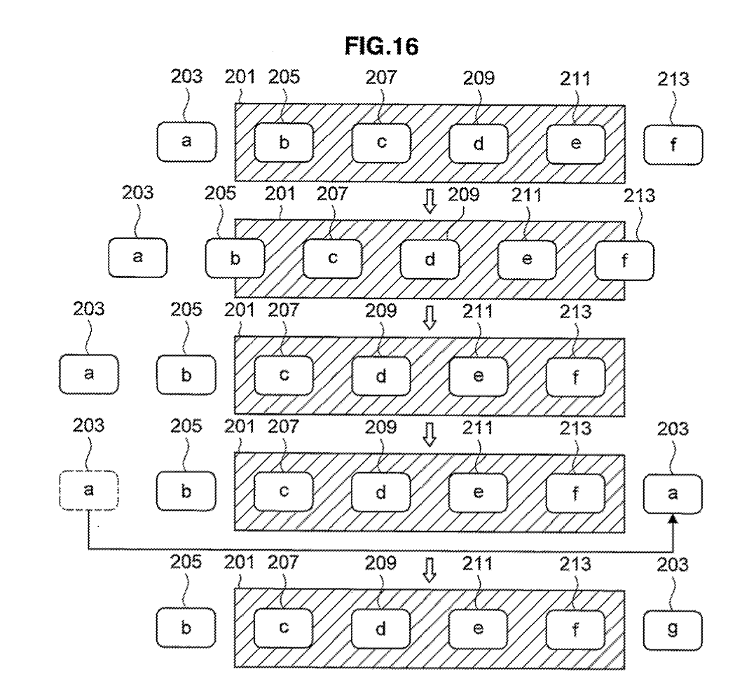

FIG. 16 is an explanatory diagram for explaining a screen scroll processing in the right-left direction which the information processing unit 100 implements in case where six object display regions which the information processing unit 100 can use are provided while four object display regions are displayed in the display region 201 provided in the display portion 105.

As shown in a top view of FIG. 16, six object display regions, 203 to 213 exist and six object data indicated with a to f are allocated to the object display regions, respectively. The object display regions to which the object data are allocated function as an object such as an icon and avatar, respectively. Four object display regions 205 to 211 are displayed in the display region 201.

Assume that user of the information processing unit 100 scrolls the object display regions 205 to 211 in a leftward direction by operating a pointing device such as the mouse, key board, and input key. A user's operation is detected by the operation detecting portion 107 of the information processing unit 100, so that user's scrolling operation in the leftward direction is notified to the object display region move control portion 101. The object display region move control portion 101 moves the object display regions 203 and 213 not displayed in the display portion 201 as well as the object display regions 205 to 211 displayed in the display region 201 in the leftward direction. At this time, the object display region move control portion 101 moves the entire object display regions 203 to 213 smoothly in the leftward direction as shown in a second view from the top of FIG. 16. As a result, the object display region 205 provides a visual effect that it is going out gradually from the display region 201, and the object display region 213 provides a visual effect that it is coming into the display region 201 gradually. At this time, the object data display control portion 103 may change the transmission factor of object data allocated to the object display region accompanied by scroll of the object display region.

As a result of move control by the object display region move control portion 101, as shown in a third view from the top of FIG. 16, four object display regions 207 to 213 are displayed in the display region 201. Two object display regions 203 and 205, which are not displayed in the display region 201, are located on the left side of the object display region 207.

Here, the object display region move control portion 101, as shown in a second view from the bottom of FIG. 16, moves an object display region (object display region 203 in the example of FIG. 16) existing at a place most apart from the display region 201 (in other words, most forward place in the scroll direction) in an object display region not displayed in the display region 201 to the further backward (further rightward side) of an object (object display region 213 in the example of FIG. 15) located on the rightmost side of the object display region displayed in the display region 201 (in other words, most backward place in the scroll direction). As a result of such move control, an object display region, not displayed in the display region 201, exists one by one on the left side and right side of the object region 201.

The quantity of the object display regions which the information processing unit 100 uses in this way is preferred to be at least (quantity of the object display regions displayed in the display region 201 plus two) in a scroll direction.

Subsequently, the object data display control portion 103 changes the object data allocated to the object display region 203 from data a to data g as shown in a bottom view of FIG. 16. Here, the object data g is an object data which is displayed next to object data f when the view on the bottom of FIG. 16 is scrolled further leftward. Therefore, unless any new object data exists in the back of the object data f, the object data a is kept allocated to the object display region 203.

By such a processing, the object data of a quantity larger than that of the object display regions can be displayed using limited object display regions (six object display regions in the example shown in FIG. 16). The information processing unit using such a method can smoothly scroll the objects displayed in the display portion using the limited resource effectively.

Although in FIG. 16, a case where the object display region is scrolled in the leftward direction has been described, the same processing can be done in case where the object display region is scrolled in a rightward direction.

### (About Scroll Processing of Object Display Regions Disposed in the Form of Tiles)

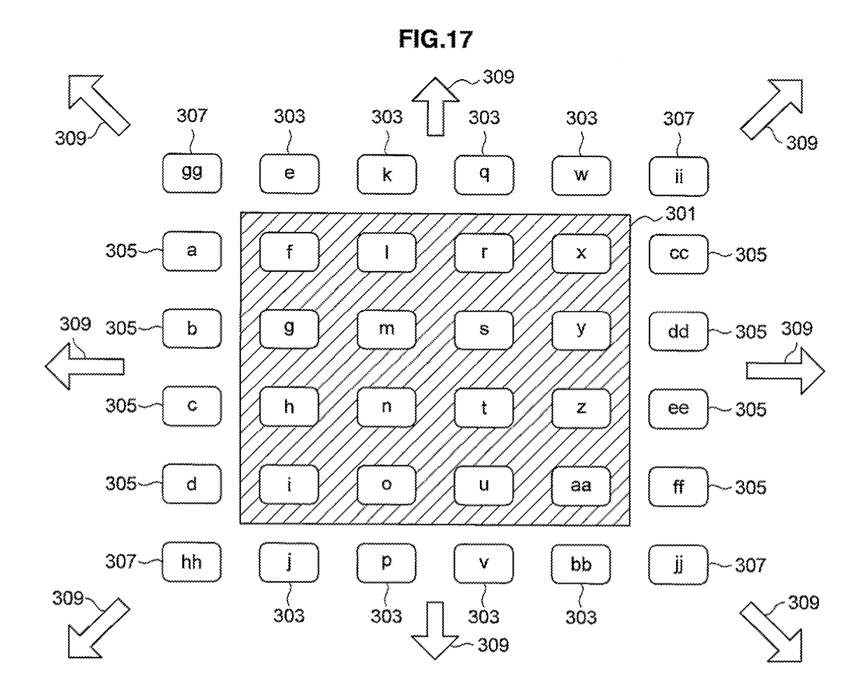

Although in FIG. 15 and FIG. 16, cases where the object display regions are arranged in a line have been described, a case where the object display regions are arranged in the form of tiles will be described in FIG. 17. FIG. 17 is an explanatory diagram for explaining a screen scroll processing which the information processing unit 100 implements in case where 36 object display regions which the information processing unit 100 can use are provided while 16 object display regions 4 rows×4 columns are displayed in the display region 301 provided in the display portion 105. An arrow 309 in FIG. 17 is represented as a scroll direction.

In such a case, the scroll processing implemented for a row or a column is the same as that described in FIG. 15 and FIG. 16. When scrolling a column in FIG. 16 in the up-down direction, the scroll processing described with reference to FIG. 15 is carried out using not-displayed object display regions 303 disposed above and below the column of the object display region displayed in the display region 301. Further when scrolling a row in FIG. 16 in the right-left direction, the scroll processing described with reference to FIG. 16 is carried out using not-displayed object display regions 305 disposed on the right side and left side of the object display region displayed in the display region 301.

Further, if the information processing unit 100 according to this embodiment permits a scroll in an oblique direction, the same processing as in FIG. 15 and FIG. 16 can be implemented using not-displayed object display regions 307.

In the scroll processing of the object display regions disposed in the form of tiles shown in FIG. 17, the object display regions of all columns displayed in the display region 301 can be moved at the same time, and the object display regions of some columns can be moved at the same time. Likewise, the object display regions of all rows displayed in the display region 301 can be moved at the same time, and the object display regions of some rows can be moved at the same time.

Although in FIG. 15 to FIG. 17, a case where the object display regions are disposed in one dimensional form or in two dimensional form has been described, the same processing can be implemented in case where the object display regions are disposed in pseudo three dimensional form or three dimensional form.

(About Scroll Method of Objects in Information Processing Unit According to this Embodiment)

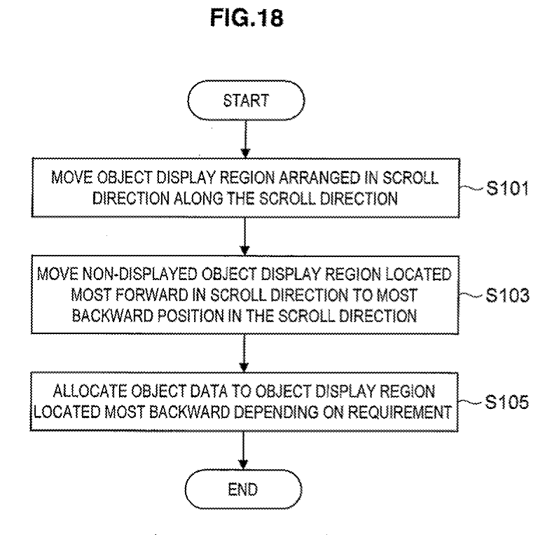

The scroll method of the object in the information processing unit 100 according to this embodiment will be described in detail with reference to FIG. 18. FIG. 18 is a flow chart for explaining the scroll method of the objects in the information processing unit 100 according to this embodiment.

When user of the information processing unit 100 makes an input for specifying a scroll direction into the input device such as the mouse and keyboard, the operation detecting portion 107 of the information processing unit 100 detects a scroll direction which user desires. Subsequently, the object display region move control portion 101 moves the object display regions arranged in the scroll direction based on the scroll direction transmitted from the operation detecting portion 107 (step S101). At the time of this move, the object display region move control portion 101 executes display control for moving the object display regions smoothly. At this time, the object data display control portion 103 may change the transmission factor of the object data allocated to the object display region accompanied by the scroll of the object display region.

Subsequently, the object display region move control portion 101 moves a not displayed object display region located at the most forward place in the scroll direction to the most backward place in the scroll direction (step S103). By such a move control, the not-displayed object display regions mostly exist on both sides of a display region of the display portion.

Next, the object data display control portion 103 allocates the object data to the object display region located at the most backward place as required (step S105). As a result of such processing, if a scroll instruction for the object in the same direction is inputted subsequent to a series of the processing, the scroll processing of the objects can be executed easily.

In the scroll method of the objects according to this embodiment, only the object display region in which the object data is displayed is moved effectively. After the move processing for the object display region is completed, the object data is allocated to the object display regions already moved. Consequently, object data of a quantity larger than that of the object display regions can be displayed using such limited object display regions. Further, in the information processing unit using such a method, the objects displayed in the display portion can be scrolled smoothly using the limited resource effectively.

### <About Hardware Configuration of Information Processing Unit>

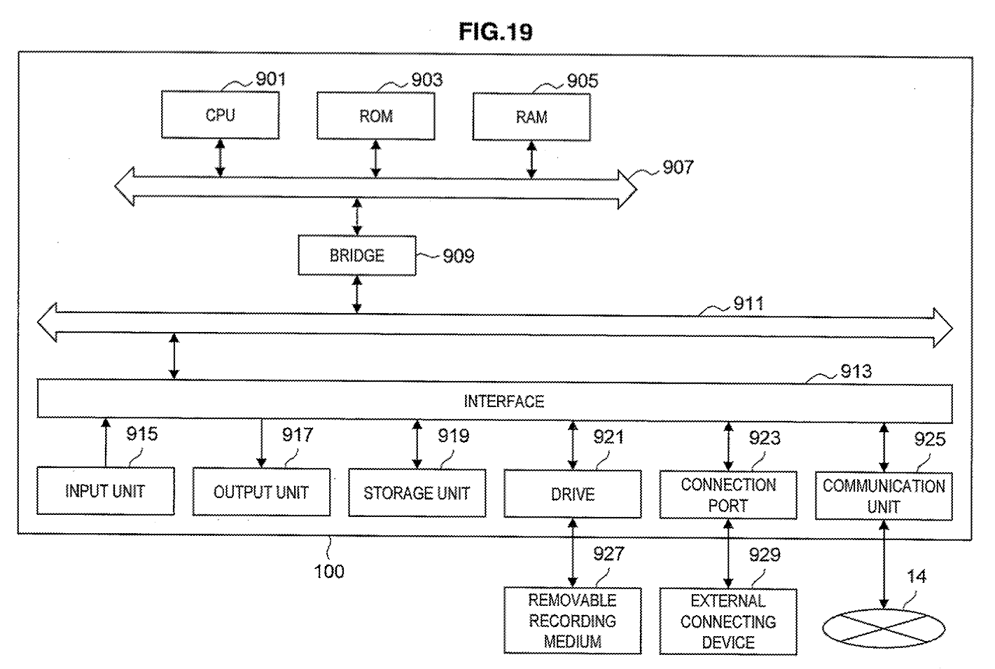

Next, the hardware configuration of the information processing unit 100 according to this embodiment will be described in detail with reference to FIG. 19. FIG. 19 is a block diagram for explaining the hardware configuration of the information processing unit 100 according to this embodiment.

The information processing unit 100 mainly includes a CPU 901, ROM 903, RAM 905, host bus 907, bridge 909, external bus 911, interface 913, input device 915, output device 917, storage device 919, drive 921, connection port 923 and communication unit 925.

The CPU 901 functions as an arithmetic operation processing unit and control unit so as to control the entire operation of the information processing unit 100 or part thereof according to various programs recorded in the ROM 903, RAM 905, storage unit 919 or removable recording medium 927. The ROM 903 memorizes a program and arithmetic operation parameters for use in the CPU 901. The RAM 905 temporarily memorizes a program which the CPU 901 uses for execution thereof and parameters which appropriately change each time upon the execution of the program. These are connected through a host bus 907 constituted of an internal bus such as the CPU bus.

The host bus 907 is connected to an external bus 911 such as peripheral component interconnect/interface (PCI) through the bridge 909.

The input device 915 is an operation unit which user operates such as a mouse, keyboard, touch panel, button, switch and lever. The input device 915 may be for example, a remote control unit using infrared ray or other electric wave or an external connection device 929 such as portable phone and PDA corresponding to operations of the information processing unit 100. Further, the input device 915 is constituted of an input control circuit, which generates an input signal based on information inputted by user using the aforementioned operation unit and outputs to the CPU 901. User of the information processing unit 100 can instruct the information processing unit 100 to input various kinds of data and perform various processing operations by operating this input device 915.

The output device 917 is constituted of a device capable of notifying user of the acquired information visually or audibly such as display unit including CRT display unit, liquid crystal display unit, plasma display unit, EL display unit, lamp, and audio output device including speaker and head phone, and printer unit, portable phone, facsimile. The output device 917 outputs a result obtained by various processings performed by the information processing unit 100. More specifically, the display unit displays the result obtained by various processings performed by the information processing unit 100 in the form of text or image. On the other hand, the audio output device converts audio signals composed of reproduced sound data and audio data to analog signals and outputs.

The storage device 919 is a data storage device constructed as an example of the memory portion of the information processing unit 100 and constituted of, for example, a magnetic memory device such as a hard disk drive (HDD), semiconductor memory device, optical memory device, photomagnetic memory device. The storage device 919 stores programs and various data to be executed by the CPU 901 and audio signal data and image signal data acquired from outside.

The drive 921 is a reader/writer for recording medium and built in or externally installed to the information processing unit 100. The drive 921 reads out information recorded in an installed removable recording medium 927 such as a magnetic disk, optical disk, photomagnetic disk, semiconductor memory and outputs to the RAM 905. The drive 921 can write a record into the installed removable recording medium 927 such as the magnetic disk, optical disk, photomagnetic disk, semiconductor memory. The removable recording medium 927 includes, for example, DVD medium, HD-DVD medium, Blu-ray medium, compact flash (CF)(registered trade mark), memory stick, secure digital memory card (SD memory card) and the like. Further, the removable recording medium 927 may be, for example, an integrated circuit card (IC card) loaded with a non-contact IC chip or an electronic device.

The connection port 923 is a port for directly connecting a device such as universal serial bus (USB) port, IEEE1394 port, for example, i.Link, small computer system interface (SCSI) port, RS-232C port, optical audio terminal, high-definition multimedia interface (HDMI) port to the information processing unit 100. By connecting the external connection device 929 to the connection port 923, the information processing unit 100 can acquire audio signal data or image signal data directly from the external connection device 929 and provide audio signal data and image signal data to the external connection device 929.

The communication device 925 is a communication interface constituted of a communication device for connecting to the communication network 14. The communication device 925 is, for example, wired or wireless local area network (LAN), Bluetooth, communication card for wireless USB (WUSB), optical communication rooter, asymmetric digital subscriber line (ADSL) rooter, or various communication modems. This communication device 925 can exchange audio signal and the like with Internet and other communication device. The communication network 14 is constituted of a network connected with wire or wirelessly, for example, Internet, home LAN, infrared ray communication, radio wave communication and satellite communication may be adopted.

An example of the hardware configuration, which can achieve functions of the information processing unit 100 according to the embodiment of the present invention has been described above. Each component may be constructed using a general purpose member or of a hardware specified for each of the components. Therefore, the hardware configuration for use can be changed appropriately corresponding to the technical level of each time when this embodiment is executed.

It should be understood by those skilled in the art that various modifications, combinations, sub-combinations and alterations may occur depending on design requirements and other factors insofar as they are within the scope of the appended claims or the equivalents thereof.

Although in the above description, a case where the object display regions are scrolled one by one by a single scroll operation has been described, the quantity of the object display regions which are scrolled by a single scroll operation may be two or more. In this case, a quantity double that of the object display regions which are scrolled by a single scroll operation is preferred to be the quantity of the object display regions not displayed in the display portion.

What is claimed is:

1. An information processing unit, comprising:
a display portion in which part of plural object display regions which function as an object by displaying object data is displayed;
an object data display control portion which allocates the object data to the plural object display regions so as to display the object data; and
an object display region move control portion which scrolls the object display region displayed in the display portion in a scroll direction based on an inputted scroll direction while scrolling the object display region not displayed in the display portion so as to display the object display region in the display portion.

2. The information processing unit according to claim 1, wherein
the object display regions are disposed in parallel in a predetermined direction, and
the scroll in the scroll direction is carried out in the unit of the row or column of the disposed object display regions.

3. The information processing unit according to claim 2, wherein
the object display region move control portion moves the object display region which comes not to be displayed in the display portion as a result of the scroll in the scroll direction to the back of the object display region which comes to be displayed in the display portion as a result of the scroll.

4. The information processing unit according to claim 2, wherein
the quantity of the object display regions disposed in a single row or a single column is at least (quantity of the object display regions disposed in a single row or a single column in the display portion+2) or more.

5. The information processing unit according to claim 1, wherein the object data display control portion changes a transmission factor of the object data allocated to the object display region which comes not to be displayed in the display portion accompanied by move of the object display region so that the transmission factor is decreased.

6. The information processing unit according to claim 1, wherein the object data display control portion changes a transmission factor of the object data allocated to the object display region which comes to be displayed in the display portion accompanied by the move of the object display region so that the transmission factor is increased.

7. The information processing unit according to claim 1, further comprising a memory portion which records the object data, wherein the object data display control portion acquires the object data from the memory portion.

8. The information processing unit according to claim 1, wherein
the object data display control portion acquires the object data from an external device connected to the information processing unit.

9. A scroll method for scrolling an object displayed in the display portion, comprising the steps of:
scrolling plural object display regions displayed in the display portion, which function as the object when object data is displayed, according to an inputted scroll method, and displaying the object display region not displayed in the display portion, in the display portion;
moving the object display region which comes not to be displayed in the display portion as a result of the scroll in the scroll direction to the back of the object display region which comes to be displayed in the display portion as a result of the scroll; and
allocating the object data to the object display region which comes not to be displayed in the display portion after the object display region is moved.
